(19) United States
(12) Patent Application Publication
(10) Pub. No.: US 2002/0118153 A1
(43) Pub. Date: Aug. 29, 2002

(54) Display device, driving method therefor, electro-optical device, driving method therefor, and electronic apparatus

(75) Inventor: Mutsumi Kimura, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/036,396

(22) Filed: Jan. 7, 2002

(30) Foreign Application Priority Data
Jan. 9, 2001 (JP) 2001-001853

(51) Int. Cl. G09G 3/36

(52) U.S. Cl. 345/87

(57) ABSTRACT

An electro-optical device including pixels disposed in a matrix at intersections of a plurality of signal lines and a plurality of scanning lines, each of said pixels including sub-pixels each provided with a static random access memory and an electro-optical element.

### FIELD OF THE INVENTION

The present invention particularly relates to a display device suitable for reducing power consumption, a driving method therefor, an electro-optical device, a driving method therefor, and an electronic apparatus.

### DESCRIPTION OF THE RELATED ART

One of important functions required for display devices is a grayscale display function, and several grayscale systems are employed. Typical grayscale display methods are: (i) a method perfoming control of an analog current or an analog voltage applied to pixels; (ii) an area-ratio grayscale method performing control of the display states of sub-pixels forming the pixels to either the ON state or the OFF state and by changing the ratio of the number of sub-pixels in the ON state to the number of sub-pixels in the OFF state; and (iii) a time-ratio grayscale method performing control of the period during which pixels are in the ON state and the period during which pixels are in the OFF state.

### PROBLEMS TO BE SOLVED BY INVENTIONS

Recent portable apparatuses, such as cellular telephones, have display devices, such as liquid crystal display devices and organic electro-luminescence display devices, therein.

Accordingly, there are increasing demands not only for providing a grayscale display function, but also for reducing the power consumption and increasing the life of display devices.

Accordingly, it is one object of the present inventions to provide a display device that can realize lower power consumption and a longer life, and also to provide a driving method suitable for reducing power consumption and prolonging a life of display device.

### SUMMARY OF THE INVENTION

A display device of the present invention is a display device in which pixels are disposed in a matrix, each of the pixels including a plurality of sub-pixels, wherein the sub-pixels each include a static random access memory. Since each pixel of the display device includes a plurality of sub-pixels, grayscale display can be performed by controlling the display state of each sub-pixel. Also in this display device, since each sub-pixel includes a static random access memory, it is not necessary to supply a scanning signal to the sub-pixel except when display data is rewritten, thereby making it possible to decrease the scanning frequency or reduce the scanning operations. Accordingly, this configuration is effective for lower power consumption and prolonging a device life. As the static random access memories for the display device, not only regular static random access memories, but also pseudo-static random access memories or synchronous static random access memories may be used.

In the above-described display device, the sub-pixels may be set in either an ON state or an OFF state. With this arrangement, it is possible to easily control the display state by electrical signals. If the sub-pixels are controlled by thin-film transistors (hereinafter referred to as “TFTs”), it is possible to minimize the influence of variations in the characteristics on the display state.

In the above-described display device, a grayscale level may be set by a function of the ratio of the maximum luminance level of each of the pixels to the sum of luminance levels of the sub-pixels in the ON state in the each of the pixel. Each sub-pixel exhibiting a predetermined luminance level when it is in the ON state is controlled to be either in the ON state or the OFF state, and the sum of the luminance levels of the sub-pixels which are in the ON state is changed according to the image signal, thereby performing grayscale display. Accordingly, even if there is a variation in the photoelectric characteristics in the individual sub-pixels, grayscale display can be performed. The maximum grayscale level is the sum of the luminance levels when all the sub-pixels contained in each pixel are in the ON state.

In the above-described display device, a grayscale level may be set by a function of the ratio of the area occupied by each of the pixels to a total area occupied by the sub-pixels in the ON state included in the each of the pixels. In such a display device, even if there is a variation in the photoelectric characteristics in the individual sub-pixels, grayscale display can be performed.

In the above-described display device, the sub-pixels may each include a liquid crystal display element. In this case, since a liquid crystal display element is used as the display element, it is possible to respond to demands for thinner and lighter display devices.

As the liquid crystal display element, either a transmission type or a reflection type can be used. The reflection type is suitable for ensuring the aperture ratio since active elements, such as transistors, and wiring patterns can be integrated and disposed in a space under the reflection-type liquid crystal display element opposite to the light emitting side.

In the above-described display device, the sub-pixels may each include an organic electro-luminescence display element. In this case, since an organic electro-luminescence display element is used as the display element, it is possible to respond to demands for thinner and lighter display devices, and a wide viewing angle can also be obtained.

A first driving method for a display device of the present invention is a driving method for a display device in which pixels are disposed in a matrix, each of the pixels including a plurality of sub-pixels provided with a static random access memory, wherein the sub-pixels are controlled to be either in an ON state or an OFF state, and a grayscale is obtained by using the ratio of the area occupied by each of the pixels to a total area occupied by the sub-pixels in the ON state included in the each of the pixels.

A second driving method for a display device of the present invention is a driving method for a display device in which pixels are disposed in a matrix, each of the pixels including a plurality of sub-pixels provided with a static random access memory, wherein the sub-pixels are controlled to be either in an ON state or an OFF state, and a grayscale is obtained by using the ratio of the maximum luminance level of each of the pixels to the sum of luminance levels of the sub-pixels whichin the ON state in the each of the pixels.

In the above-described driving methods for display devices, even when halftone grayscale levels are displayed, only the ON state or the OFF state of the sub-pixels are used. Accordingly, even if there is a variation in the photoelectric characteristics in the individual sub-pixels, grayscale display can be performed.

A first electro-optical device of the present invention is an electro-optical device including pixels disposed in a matrix at intersections of a plurality of signal lines and a plurality of scanning lines, wherein each of the pixels includes sub-pixels each provided with a static random access memory and an electro-optical element.

In the above-described electro-optical device, the luminance of each of the electro-optical elements has two values including a lower luminance level and a higher luminance level. The two values indicate, for example, a luminance level of zero and the maximum luminance level, respectively. With this arrangement, the data signal supplied to the pixel via the signal line can be simplified. Accordingly, the circuit configuration of the signal-line drive circuit can also be simplified, and the area occupied by the signal-line drive circuit can also be reduced.

In the above-described electro-optical device, a grayscale level may be set as a function of the sum of luminance levels of the electro-optical elements contained in the pixel.

In the above-described electro-optical device, a grayscale level may be set as a function of the ratio of a total area occupied by all the electro-optical elements contained in one of the pixels to a total area occupied by the electro-optical elements that are set at the higher luminance level.

In the above-described electro-optical device, the electro-optical elements may be liquid crystal elements. As the liquid crystal display elements, either a transmission type or a reflection type can be used. In order to reduce power consumption, a reflection type, which does not require a light source, is preferably used. The reflection type is also suitable for ensuring the aperture ratio since active elements, such as transistors, and wiring patterns can be integrated and disposed in a space under the reflection-type liquid crystal element opposite to the light emitting side.

In the above-described electro-optical device, the electro-optical elements may be organic electro-luminescence elements.

A driving method for an electro-optical device of the present invention is a driving method for an electro-optical device including pixels disposed in a matrix at intersections of a plurality of signal lines and a plurality of scanning lines, sub-pixels each provided with an electro-optical element being disposed within the pixel. The driving method includes: a step of supplying a data signal for controlling a luminance level of the electro-optical elements to either a higher luminance level or a lower luminance level via the plurality of signal lines; and a step of retaining the data signal in a static random access memory disposed within each of the sub-pixels.

In the above-described driving method for an electro-optical device, the lower luminance level and the higher luminance level of the electro-optical elements may be set to a luminance level of zero and the maximum luminance level, respectively.

An electronic apparatus of the present invention is provided with the above-described display device or the electro-optical device.

### BRIEF DESCRIPTION OF THE DRAWINGS

FIG. 1

FIG. 1 is a pixel equivalent circuit diagram of a first embodiment according to the present invention.

FIG. 2

FIG. 2 illustrates a manufacturing process for a tin-film transistor of the first embodiment according to the present invention.

FIG. 3

FIG. 3 is a pixel equivalent circuit diagram of a second embodiment according to the present invention.

FIG. 4

FIG. 4 illustrates a manufacturing processing for an organic electro-luminescence display element of a second embodiment according to the present invention.

FIG. 5

FIG. 5 illustrates an example of a mobile personal computer to which an electro-optical device according to the present invention is applied.

FIG. 6

FIG. 6 illustrates an example of a cellular telephone to which an electro-optical device according to the present invention is applied.

FIG. 7

FIG. 7 illustrates an example of a digital still camera having a finder to which an electro-optical device according to the present invention is applied.

### EMBODIMENTS

Typical embodiments of the present invention are described below.

(First Embodiment)

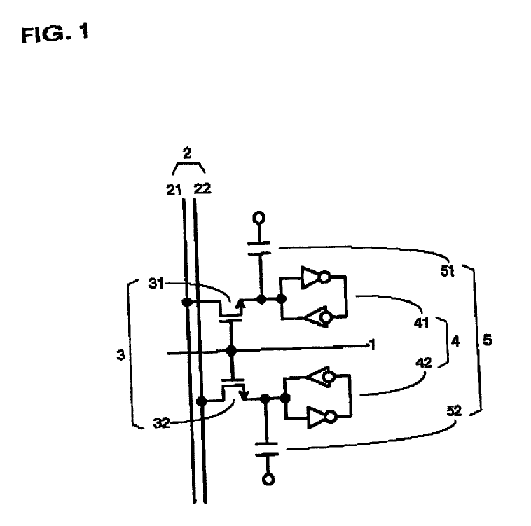

As an embodiment of the present invention, a display device is described below in which a plurality of sub-pixels each provided with a liquid crystal element and a static random access memory are disposed as electro-optical elements within one pixel. FIG. 1 is an equivalent circuit diagram of a pixel of the display device. Although only one pixel is shown in FIG. 1, in practice, a plurality of pixels are disposed in a matrix at the intersections of scanning lines for sending scanning signals to pixels and signal lines for sending data signals to the pixels. Within one pixel, transistors 3, static random access memories 4, and liquid crystal elements 5 are formed. As the transistors 3, thin-film transistors (TFTs), silicon-based transistors, or so-called organic transistors using an aromatic or conjugated organic semiconductor material as a semiconductor layer can be employed. Thin-film transistors include, for example, amorphous silicon thin-film transistors, polycrystalline thin-film transistors, and monocrystalline transistors. If the silicon-based transistors are utilized, it is preferable that transistors formed on a silicon substrate be divided into chips including a single transistor or a plurality of transistors, and the divided chips are then re-disposed at predetermined positions of an insulating substrate, such as glass. The silicon-based transistors produced as described above are then used as the thin-film transistors.

As the static random access memories 4, CMOS-inverter-type static random access memories, depletion-load-type memories or high-resistance polycrystalline silicon load-type memories can be used. As the transistors forming the static random access memories 4, a transistor type similar to the transistors 3 can be used. However, in order to exhibit the functions as the static random access memories 4, polycrystalline silicon thin-film transistors, a monocrystalline silicon transistors, or silicon-based transistors are preferably used. As the liquid crystal elements 5, either transmission-type liquid crystal elements or reflection-type liquid crystal elements can be used. However, if it is necessary to reduce the power consumption, reflection-type liquid crystal devices which do not need a light source, such as backlight, are preferable.

It is preferable that signal lines be provided according to the number of bits of the data signal. For example, if a two-bit data signal is supplied, a lower-bit signal line 21 and a higher-bit signal line 22 are provided as signal lines 2, as indicated by the equivalent circuit diagram shown in FIG. 1.

In accordance with these signal lines, a lower-bit transistor 31 and a higher-bit transistor 32 are disposed as the transistors 3. Similarly, as the static random access memories 4, a lower-bit static random access memory 41 and a higher-bit random access memory 42 are disposed as the static random access memory 4. As the liquid crystal elements 5, a lower-bit liquid crystal element 51 and a higher-bit liquid crystal element 52 are disposed.

The static random access memories 41 and 42 can be directly connected to the word line (or scanning line) and the data line. Alternatively, as shown in FIG. 1, the static random access memories 41 and 42 may be disposed such that they are connected to the signal lines 2 via the transistors 3 whose gates are connected to a scanning line 1. With this arrangement, it is not necessary to provide scanning lines (word lines) according to the number of sub-pixels. Accordingly, an undesirable wiring capacitance generated between wiring patterns can be reduced, thereby preventing a delay caused when data is rewritten.

According to the data signals supplied from the signal lines 21 and 22, the luminance levels of each of the liquid crystal elements 51 and 52 are preferably set to two values, i.e., a high level and a low level (for example, a luminance of 0 and the maximum luminance), respectively. For example, the lower luminance levels of the liquid crystal elements 51 and 52 are set to be the same (for example, a luminance of 0), while the higher luminance levels thereof are set at a ratio of 1:2. As a result, four grayscale levels can be obtained with a two-bit data signal. If the average luminance (luminance per unit area) of the lower luminance level and the higher luminance level of the liquid crystal element 51 is substantially the same as that of the liquid crystal element 52, the area of the liquid crystal element 51 is differentiated from that of the liquid crystal element 52, thereby obtaining the maximum number of grayscale levels in response to a supplied data signal. For example, by setting the ratio of the area of the liquid crystal element 52 to that of the liquid crystal element 51 to 2:1, four grayscale levels can be obtained with a two-bit data signal.

If a static random access memory is not used, a selection pulse must be supplied to the pixel circuit via a scanning line at regular intervals. In this embodiment, however, by using the static random access memories 4 as storage elements, a selection pulse is supplied to the pixel circuit only when data is subsequently rewritten. That is, while a selection pulse is applied to the scanning line 1, a data signal is applied to the signal lines 2 and is then supplied to the static random access memories 4 via the transistors 3. The supplied data signal is retained in the static random access memories 4 until data is subsequently rewritten. Light reflection or light transmission of the liquid crystal elements 5 is controlled based on the data retained in the static random access memories 4.

As the liquid crystal elements 5, reflection-type liquid crystal elements which do not need a light source, such as backlight, are suitable for reducing power consumption. Although in the equivalent circuit shown in FIG. 1 a 2-bit data signal is supplied, a data signal having 3 or more bits may be supplied. In this case, the concept of the present invention can be maintained.

(Second Embodiment)

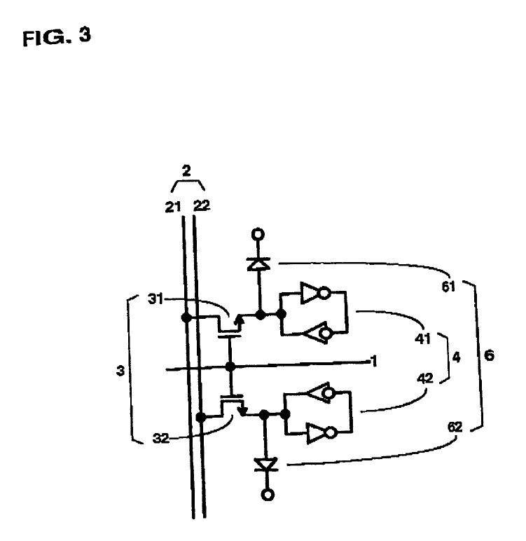

As an embodiment of the present invention, a display device is described below in which a plurality of sub-pixels provided with organic electro-luminescence elements 6 and static random access memories 4 are disposed as electro-optical elements within one pixel. FIG. 3 is an equivalent circuit diagram of a pixel of the display device. Although only one pixel is shown in FIG. 3, in practice, a plurality of pixels are disposed in a matrix at the intersections of scanning lines for sending scanning signals to the pixels and signal lines for sending data signals to the pixels. Transistors 3, the static random access memories 4, and the organic electro-luminescence elements are formed in one pixel. As the transistors 3, thin-film transistors (TFTs), silicon-based transistors, or so-called organic transistors using an aromatic or conjugated organic semiconductor material as a semiconductor layer can be used. Thin-film transistors include, for example, amorphous silicon thin-film transistors, polycrystalline thin-film transistors, and monocrystalline transistors. If silicon-based transistors are utilized, it is preferable that transistors formed on a silicon substrate be divided into chips including a single transistor or a plurality of transistors, and the divided chips are then re-disposed at predetermined positions of an insulating substrate, such as glass. The silicon-based transistors produced as described above are then used as the thin-film transistors.

As the static random access memories 4, CMOS-inverter-type static random access memories, depletion-load-type memories, high-resistance polycrystalline silicon load-type memories can be used. As the transistors forming the static random access memories 4, a transistor type similar to the transistors 3 can be used. However, in order to exhibit the functions as the static random access memories 4, polycrystalline silicon thin-film transistors, monocrystalline silicon transistors, or silicon-based transistors are preferably used.

As the luminance material for the organic electro-luminescence elements 6, polymer materials, such as polyphenylenes and polyphenylene vinylenes, or low-molecular-weight materials, such as coumarine and rhodamine, can be used.

It is preferable that signal lines be provided according to the number of bits of the data signal. For example, if a two-bit data signal is supplied, a lower-bit signal line 21 and a higher-bit signal line 22 are provided as signal lines 2, as indicated by the equivalent circuit diagram shown in FIG. 3.

In accordance with these signal lines, a lower-bit transistor 31 and a higher-bit transistor 32 are disposed as the transistors 3. Similarly, as the static random access memories 4, a lower-bit static random access memory 41 and a higher-bit static random access memory 42 are disposed. As the organic electro-luminescence elements 6, a lower-bit organic electro-luminescence element 61 and a higher-bit electro-luminescence element 62 are disposed.

The static random access memories 41 and 42 can be directly connected to the word line (or scanning line) and the data line. Alternatively, as shown in FIG. 3, the static random access memories 41 and 42 may be disposed such that they are connected to the signal line 2 via the transistors 3 whose gates are connected to the scanning line 1. With this arrangement, it is not necessary to provide scanning lines (word lines) according to the number of sub-pixels. Accordingly, an undesirable wiring capacitance generated between wiring patterns can be reduced, thereby preventing a delay caused when data is rewritten. Additionally, in particular, in a so-called back-emission-type display device for allowing light to be emitted from the circuit substrate on which transistors and wiring patterns are disposed, the light emission efficiency is improved with a smaller number of transistors and wiring patterns.

According to the data signals supplied from the signal lines 21 and 22, the luminance levels of each of the organic electro-luminescence elements 61 and 62 are preferably set to two values, i.e., a high level and a low level (for example, a luminance of 0 and the maximum luminance), respectively. For example, the lower luminance levels of the organic electro-luminescence elements 61 and 62 are set to be the same (for example, a luminance of 0), while the higher luminance levels thereof are set at a ratio of 1:2. As a result, four grayscale levels can be obtained with a two-bit data signal. If the average luminance (luminance per unit area) of the lower luminance level and the higher luminance level of the organic electro-luminescence element 61 is substantially the same as that of the organic electro-luminescence element 62, the area of the organic electro-luminescence element 61 is differentiated from that of the organic electro-luminescence element 62, thereby obtaining the maximum number of grayscale levels in response to a supplied data signal. For example, by setting the ratio of the area of the organic electro-luminescence element 62 to that of the organic electro-luminescence element 61 to 2:1, four grayscale levels can be obtained with a two-bit data signal.

If static random access memories are not used, a selection pulse must be supplied to the pixel circuit via the scanning line at regular intervals. In this embodiment, however, by using the static random access memories 4 as storage elements, a selection pulse can be supplied to the pixel circuit only when data is rewritten. That is, while a selection pulse is applied to the scanning line 1, a data signal is applied to the signal lines 2 and is then supplied to the static random access memories 4 via the transistors 3. The supplied data signal is retained in the static random access memories 4 until data is subsequently rewritten. The luminance intensity of the organic electro-luminescence elements 6 is controlled based on the data retained in the static random access memories 4.

Generally, organic electro-luminescence elements using polymer materials are driven at a lower voltage than those using low-molecular-weight materials. Therefore, the amount of current supplied to the organic electro-luminescence elements using polymer materials can be reduced. On the other hand, in order to obtain many grayscale levels, it is necessary to precisely control the amount of current supplied to the organic electro-luminescence elements. As in this embodiment, if the luminance of the organic electro-luminescence element is set to two values, many grayscale levels can be obtained without the need to precisely control the amount of current.

Although in the equivalent circuit shown in FIG. 3 a 2-bit data signal is supplied, a data signal having 3 or more bits may be supplied. In this case, the concept of the present invention can be maintained.

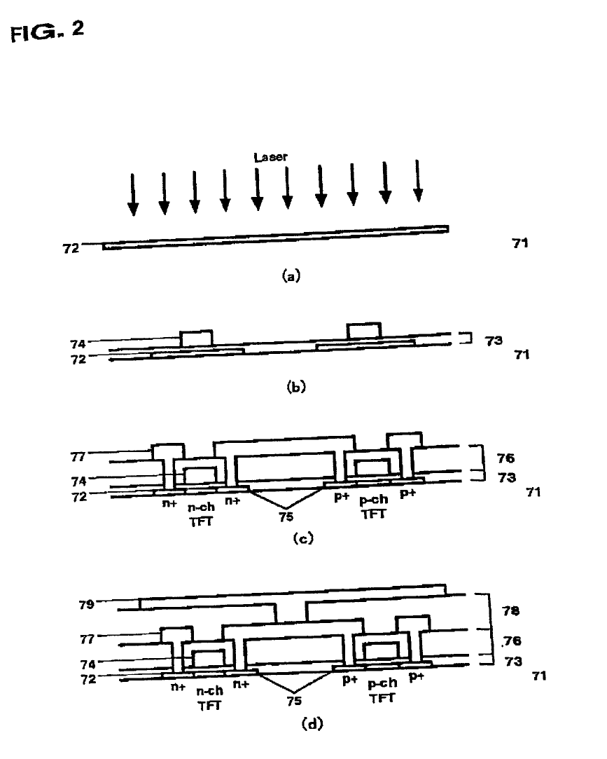

A typical manufacturing process for an electro-optical device according to the present invention is described below with reference to FIG. 2.

Amorphous silicon is first formed on a glass substrate 71 according to PECVD using SiH₄ or LPCVD using Si₂H₆. The amorphous silicon is re-crystalized by applying laser light, such as an excimer laser, or by solid-phase growth so as to form polycrystalline silicon 72 (FIG. 2(a)). After the polycrystalline silicon 72 is patterned, a gate insulating film 73 is formed, and then a gate electrode 74 is formed and patterned (FIG. 2(b)). An impurity, such as phosphorus or boron, is implanted into the polycrystalline silicon 72 using the gate electrode 74 according to a self-alignment process so as to activate the polycrystalline silicon 72, thereby forming CMOS-structured source and drain regions 75. A first interlayer insulating film 76 is formed, and contact holes are formed in which source and drain electrodes 77 are formed and patterned (FIG. 2(c)). Then, a second interlayer insulating film 78 is formed, and contact holes are formed in which a pixel electrode 79 is formed and patterned (FIG. 2(d)). The thin-film transistors are disposed behind the pixel electrode 79. Thereafter, a reflection-type liquid crystal display element is formed according to a standard process.

According to the configuration of this embodiment, in contrast to display devices using the area-ratio grayscale method, scanning is performed only when images change, thereby realizing even lower power consumption and a longer life of a drive circuit. Additionally, according to the configuration of this embodiment, static random access memories can be disposed behind the reflection-type liquid crystal display element, thereby eliminating problems such as a reduction in the aperture ratio.

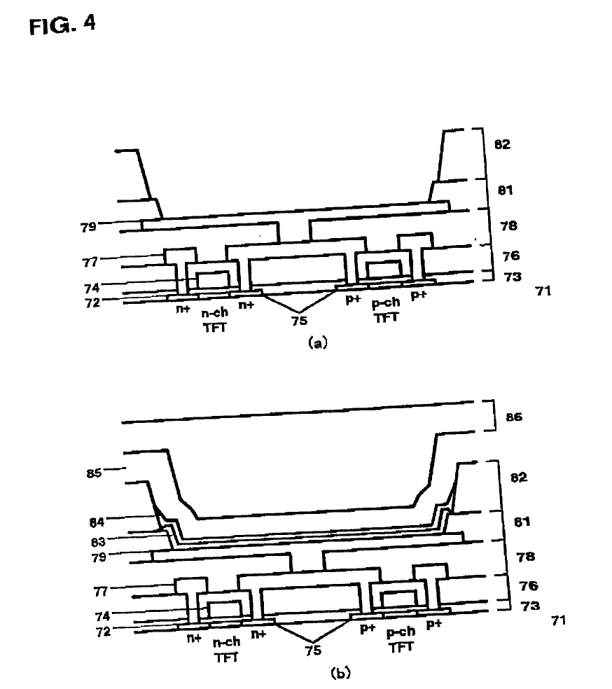

FIG. 4 illustrates a manufacturing process of an organic electro-luminescence element of the second embodiment. The manufacturing process of the thin-film transistor is similar to that of the first embodiment, as shown in FIG. 2. An adhesion layer 81 is first formed, and an opening is formed therein in which a luminescence region is formed (FIG. 4(a)). Then, the wettability of the substrate surface is controlled by plasma processing using, for example, oxygen plasma or CF₄ plasma. Thereafter, an electron-hole implantation layer 83 and a luminance layer 84 are formed according to a liquid-phase process, such as a spin-coating, squeezing, or ink-jet process (T. Shimoda, S. Seki, et al., Dig. SID '99 (1999), 376, and S. Kanbe, et al., Proc. Euro Display '99 Late-News Papers (1999), 85), or a vacuum process, such as a sputtering or deposition process. In order to decrease the work function, a cathode 85 containing an alkali metal is formed and is sealed by a sealing agent 86. Then, the organic electro-luminescence element is completed (FIG. 4(b)). The role of the adhesion layer 81 is to enhance the adhesion between the substrate and an interlayer 82 and to obtain an accurate luminance area. The role of the interlayer 82 is to separate the cathode 85 from the gate electrode 74, the source and drain electrodes 77 so as to reduce the parasitic capacitance, and to control the wettability of the surface when forming the electron-hole implantation layer 83 and the luminance layer 84 according to a liquid-phase process so as to realize accurate patterning (T. Shimoda, M. Kimura, et al., Proc. Asia Display '98, 217 (1998).

According to the configuration of this embodiment, in contrast to display devices using the area-ratio grayscale method, scanning is performed only when images change, thereby realizing even lower power consumption and a longer life of the drive circuit. Additionally, static random access memories can be disposed behind the organic electro-luminescence element display device, thereby eliminating problems such as a reduction in the aperture ratio.

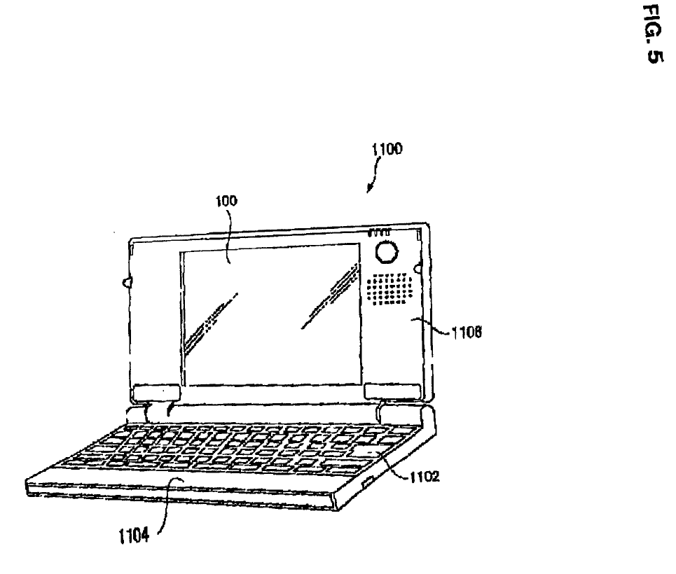

Some examples of an electronic apparatus to which the above-described electro-optical device is applied are described below. FIG. 5 is a perspective view illustrating the configuration of a mobile personal computer to which the above-described electro-optical device is applied. In this drawing, a personal computer 1100 is formed of a main unit 1104 provided with a keyboard 1102 and a display unit 1106. The display unit 1106 is provided with an electro-optical device 100.

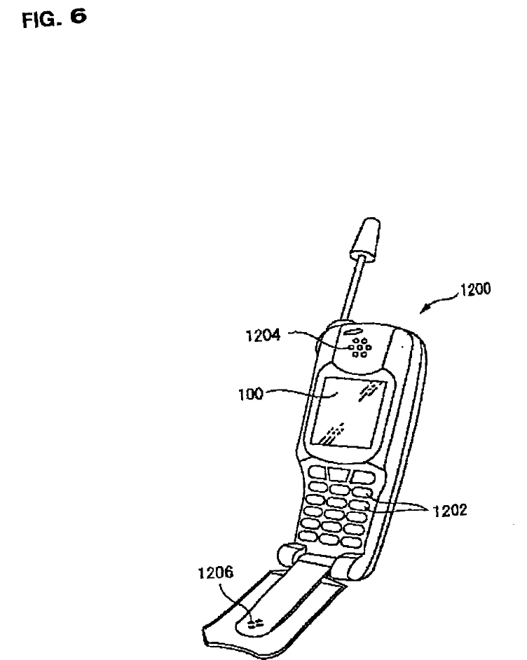

FIG. 6 is a perspective view illustrating the configuration of a cellular telephone having a display portion to which the above-described electro-optical device 100 is applied. In this drawing, a cellular telephone 1200 includes not only a plurality of operation buttons 1202, but also an earpiece 1204, a mouthpiece 1206, and the above-described electro-optical device 100.

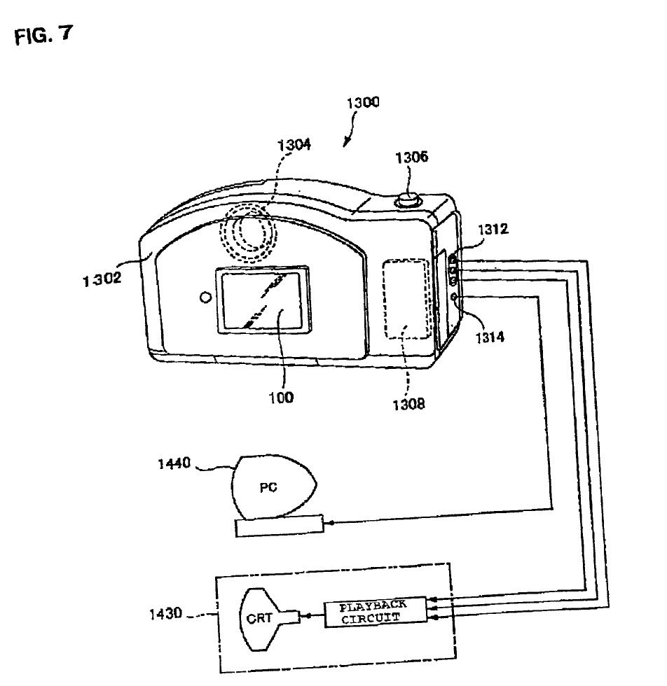

FIG. 7 is a perspective view illustrating the configuration of a digital still camera having a finder to which the above-described electro-optical device 100 is applied. FIG. 7 also schematically illustrates the connection of the digital still camera with external devices. In a regular camera, a film is exposed to light by an optical image of a subject. In a digital still camera 1300, however, an optical image of a subject is photoelectrically converted by an image pickup device, such as a CCD (Charge Coupled Device) so as to generate an imaging signal. On the rear surface of a casing 1302 of the digital still camera 1300, the aforementioned electro-optical device 100 is provided to display the subject based on the imaging signal obtained by the CCD. That is, the electro-optical device 100 serves as a finder for displaying the subject. On the observation side (on the reverse surface in FIG. 7) of the casing 1302, a photodetector unit 1304 including an optical lens and a CCD is disposed.

A photographer checks the subject displayed on the electro-optical device 100 and presses a shutter button 1306. Then, the imaging signal obtained by the CCD is transferred to and stored in a memory of a circuit board 1308. In this digital still camera 1300, a video signal output terminal 1312 and a data communication input/output terminal 1314 are provided on the side surface of the casing 1302. Then, as shown in FIG. 7, a television monitor 1430 and a personal computer 1440 can be connected to the video signal output terminal 1312 and the data communication input/output terminal 1314, respectively, as required. The imaging signal stored in the memory of the circuit board 1308 can be output to the television monitor 1430 or the personal computer 1440 by a predetermined operation.

Electronic apparatuses to which the electro-optical device 100 of the present invention is applicable include not only the personal computer shown in FIG. 5, the cellular telephone shown in FIG. 6, and the digital still camera shown in FIG. 7, but also a television, a viewfinder-type or direct-view-type video cassette recorder, a car navigation system, a pager, an electronic diary, a calculator, a word processor, a workstation, a videophone, a POS terminal, a device provided with a touch panel, and so on. It is needless to say that the above-described electro-optical device 100 is applicable to the display units of the above-mentioned electronic apparatuses.

### DETAILED DESCRIPTION OF THE INVENTION

[Reference Numerals]

1 scanning line

2 signal lines

21 lower-bit signal line

22 higher-bit signal line

3 thin-film transistors

31 lower-bit thin-film transistor

32 higher-bit thin-film transistor

4 static random access memories

41 lower-bit static random access memory

42 higher-bit static random access memory

5 reflection-type liquid crystal display elements

51 sub lower-bit reflection-type liquid crystal display element

52 sub higher-bit reflection-type liquid crystal display element

6 organic electro-luminescence display elements

61 sub lower-bit organic electro-luminescence display element

62 sub higher-bit organic electro-luminescence display element

71 glass substrate

72 poly-crystal silicon

73 gate insulating film

74 gate electrode

75 source region and drain region

76 first interlayer insulating film

77 source electrode and drain electrode

78 second interlayer insulating film

79 pixel electrode

81 adhesion layer

82 interlayer

83 electron-hole implantation layer

84 luminance layer

85 cathode

86 sealing agent

What is claimed is:

1. A display device in which pixels are disposed in a matrix, each of said pixels including a plurality of sub-pixels, said sub-pixels each including a static random access memory.

2. The display device according to claim 1, said sub-pixels being set in either an ON state or an OFF state.

3. The display device according to claim 2, a grayscale level being set by a function of a ratio of the maximum luminance level of each of said pixels to the sum of luminance levels of all of said sub-pixels included in the each of said pixels.

4. The display device according to claim 2, a grayscale level being set by a function of a ratio of an area occupied by each of said pixels to a total area occupied by the sub-pixels in the ON state included in the each of said pixels.

5. The display device according to any one of claims 1 to 4, said sub-pixels each including a liquid crystal display element.

6. The display device according to claim 5, said liquid crystal display element being a reflection-type liquid crystal display element.

7. The display device according to any one of claims 1 to 4, said sub-pixels each including an organic electro-luminescence display element.

8. A driving method for a display device in which pixels are disposed in a matrix, each of said pixels including a plurality of sub-pixels provided with a static random access memory, said sub-pixels being controlled to be either in an ON state or an OFF state, and a grayscale being obtained by using a ratio of an area occupied by each of said pixels to a total area occupied by the sub-pixels in the ON state included in the each of said pixels.

9. A driving method for a display device in which pixels are disposed in a matrix, each of said pixels including a plurality of sub-pixels provided with a static random access memory, said sub-pixels being controlled to be either in an ON state or an OFF state, and a grayscale being obtained by using a ratio of the maximum luminance level of each of said pixels to the sum of luminance levels of the sub-pixels in the ON state included in the each of said pixels.

10. An electro-optical device including pixels disposed in a matrix at intersections of a plurality of signal lines and a plurality of scanning lines, each of said pixels including sub-pixels each provided with a static random access memory and an electro-optical element.

11. The electro-optical device according to claim 10, the luminance of each of said electro-optical elements having two values including a lower luminance level and a higher luminance level.

12. The electro-optical device according to claim 11, a grayscale level being set as a function of the sum of luminance levels of said electro-optical elements contained in each of said pixel.

13. The electro-optical device according to claim 11, a grayscale level being set as a function of a ratio of a total area occupied by all the electro-optical elements contained in one of said pixels to a total area occupied by the electro-optical elements which are set at the higher luminance level.

14. The electro-optical device according to any one of claims 10 to 13, said electro-optical elements being liquid crystal elements.

15. The electro-optical device according to claim 14, said liquid crystal elements being reflection-type liquid crystal elements.

16. The electro-optical device according to any one of claims 10 to 13, said electro-optical elements being organic electro-luminescence elements.

17. A driving method for an electro-optical device including pixels disposed in a matrix at intersections of a plurality of signal lines and a plurality of scanning lines, sub-pixels each provided with an electro-optical element being disposed within said pixel, said driving method comprising:
a step of supplying a data signal for controlling a luminance level of said electro-optical elements to either a higher luminance level or a lower luminance level via said plurality of signal lines; and
a step of retaining the data signal in a static random access memory disposed within each of said sub-pixels.

18. A driving method for an electro-optical device in which pixels are disposed in a matrix, each of said pixels including a plurality of sub-pixels provided with a static random access memory, said sub-pixels being controlled to either an ON state or an OFF state, and a grayscale being obtained by using a ratio of the maximum luminance level of each of said pixels to the sum of luminance levels of the sub-pixels in the ON state included in the each of said pixels.

19. An electronic apparatus comprising the display device set forth in any one of claims 1 to 7.

20. An electronic apparatus comprising the electro-optical device set forth in any one of claims 10 to 16.
